(19) United States
(12) Patent Application Publication
(10) Pub. No.: US 2004/0113797 A1
(43) Pub. Date: Jun. 17, 2004

(54) System and method for alerting an operator to the presence of an occupant in a vehicle

(76) Inventor: John Osborne, Chicago, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/254,479

(22) Filed: Dec. 16, 2002

(51) Int. Cl. G08B 23/00

(52) U.S. Cl. 340/573.4

(57) ABSTRACT

A method of monitoring the presence of an occupant in a passenger compartment of a moving vehicle having an operating engine with on and off states. The method includes the steps of: providing a sensing system on the moving vehicle which detects the presence of an occupant in the passenger compartment of the moving vehicle; providing a detectable signal generator; and causing the detectable signal generator to generate a detectable signal in the event that at least one of a) the temperature in the passenger compartment changes to above or below a predetermined temperature with the sensing system detecting the presence of an occupant in the passenger compartment of the moving vehicle, b) the operating engine is in the off state with the sensing system detecting the presence of an occupant in the passenger compartment of the moving vehicle, c) a user exits from the vehicle with the sensing system detecting the presence of an occupant in the passenger compartment of the moving vehicle, and d) the operating engine is changed from the on state to the off state with the sensing system detecting the presence of an occupant in the passenger compartment of the moving vehicle.

### BACKGROUND OF THE INVENTION

1. Field of the Invention

This invention relates to moving vehicles and, more particularly, to a method and apparatus for alerting an exiting operator, or another person, that an occupant remains in the vehicle.

2. Background Art

As everyday life becomes increasingly more hectic, single parents and couples with children encounter more and more problems coordinating the care of their children as they embark upon their work day routines. As part of a morning ritual, infants are commonly transported by car to the residence of a relative or other caretaker in the early morning hours before, or on the way to, work. It is a common sight to see clock-watching parents rushing infants to a care site and then dashing to make a timely arrival at the workplace.

Recent changes in the law have required young children below a certain age to be restrained in the back seats of vehicles. It is no longer an uncommon event for distracted parents to embark upon their morning ritual and, in a frantic state, forget that a child has been placed in a restraint in the back seat of their vehicle. News broadcasts are often heard about parents absentmindedly leaving an infant in the back seat of a vehicle for hours on days of extreme heat, often resulting in the death of the infant.

The above situations often arise with infants left in the custody of a relative that does not typically care for an infant and having minds not programmed to recall the presence of the infant in the vehicle. Such catastrophic events are also known to be caused by elderly custodians that are either forgetful or have a momentary mental lapse.

Dangerous situations also arise when the custodian of a child misjudges the conditions that develop in a closed vehicle as a short errand is carried out, such as a trip to a grocery store, etc. While it is certainly never advisable to leave a child unattended in a restraint in a vehicle, the reality is that these situations do occur. Conditions can become stifling in a closed vehicle in extreme heat in a very short period of time. Underestimation of the severity of developing conditions can lead to a catastrophic event.

There are still other situations in which infants or children may be dangerously left in an unoccupied vehicle. There have been situations where school bus drivers have returned vehicles to a yard at the end of a run with a sleeping child still in the vehicle. While this situation may not be as dangerous as those described above, the emotional trauma associated with a lost child, even for short periods, can be devastating and has led to legal action against the responsible individuals.

As the pace of day-to-day life become increasingly more frantic, the need to avoid situations, as described above, becomes paramount. However, to the knowledge of the inventor herein, no effective steps have been taken to avoid the future recurrence of the often dangerous and life threatening events described above.

### SUMMARY OF THE INVENTION

In one form, the invention is directed to a method of monitoring the presence of an occupant in a passenger compartment of a moving vehicle having an operating engine with on and off states. The method includes the steps of: providing a sensing system on the moving vehicle which detects the presence of an occupant in the passenger compartment of the moving vehicle; providing a detectable signal generator; and causing the detectable signal generator to generate a detectable signal in the event that at least one of a) the temperature in the passenger compartment changes to above or below a predetermined temperature with the sensing system detecting the presence of an occupant in the passenger compartment of the moving vehicle, b) the operating engine is in the off state with the sensing system detecting the presence of an occupant in the passenger compartment of the moving vehicle, c) a user exits from the vehicle with the sensing system detecting the presence of an occupant in the passenger compartment of the moving vehicle, and d) the operating engine is changed from the on state to the off state with the sensing system detecting the presence of an occupant in the passenger compartment of the moving vehicle.

In one form, the step of causing the detectable signal generator to generate a detectable signal involves placing a temperature sensor in the passenger compartment of the moving vehicle and causing the temperature sensor to generate an activating signal upon the temperature in the passenger compartment changing to above or below the predetermined temperature to thereby cause the signal generator to generate the detectable signal.

The detectable signal generator may be at least one of a) a sound generator, b) an illumination source, c) a visual display, d) a mechanical assembly that is capable of changing state, and e) a horn.

In one form, the sensing system is a pressure responsive sensor which is changeable from a first state into a second state upon detecting the presence of a passenger in the passenger compartment of the moving vehicle.

The sensing system may be a sensor for motion within the passenger compartment of the moving vehicle.

In one form, the sensing system is operably associated with a child safety seat in the passenger compartment of the moving vehicle.

The method may further include the step of providing an exit sensor which is changeable from a first state into a second state upon detecting that the exit door has one of a) opened and b) opened and closed. The exit sensor generates an activating signal as an incident of the exit sensor changing from the first state into the second state to thereby cause the detectable signal generator to generate a detectable signal.

The method may further include the step of providing an engine state sensor which is changeable from a first state into a second state as an incident of the engine being changed from the on state into the off state. The engine state sensor generates an activating signal as an incident of the engine state sensor changing from the first state into the second state to thereby cause the detectable signal generator to generate a detectable signal.

In one form, the activating signal is generated from the engine state sensor only after a predetermined time lapse after the engine state sensor is changed from the first state into the second state.

The invention is further directed to the combination of a moving vehicle having a passenger compartment, an operating engine having on and off states, and an exit door that can be selectively opened and closed with a system for monitoring the presence of an occupant in the passenger compartment of the moving vehicle. In one form, the monitoring system has a sensing system and a detectable signal generator. The sensing system is capable of detecting the presence of an occupant in the passenger compartment of the moving vehicle. The detectable signal generator is capable of generating a detectable signal in the event that: a) at least one of i) the temperature in the passenger compartment changes to above or below a predetermined temperature, ii) the operating engine is in the off state, iii) the user exits from the vehicle, and iv) the operating engine is changed from the on state into the off state; and b) the sensing system detects the presence of a occupant in the passenger compartment of the moving vehicle.

The sensing system contemplated in this combination may include at least the various structural details described above relative to the method.

The invention is further directed to a system for monitoring the presence of an occupant in the passenger compartment of a moving vehicle having an operating engine with on and off states and an exit door that can be selectively opened and closed. The monitoring system has a sensing system capable of detecting the presence of an occupant in the passenger compartment of the moving vehicle, a detectable signal generator, and a sensor capable of detecting a state for the vehicle that could be detrimental to an occupant in the passenger compartment of the moving vehicle. The sensor generates an activating signal upon detecting the moving vehicle state, thereby causing the detectable signal generator to generate a detectable signal with the sensing system detecting the presence of an occupant in the moving vehicle.

In one form, the moving vehicle state in the passenger compartment is established upon the temperature in the passenger compartment of the moving vehicle changing to above or below a predetermined temperature.

In one form, the moving vehicle state is established by opening and closing the exit door.

In still another form, the moving vehicle state is established by changing the engine from the on state to the off state.

In yet another form, the moving vehicle state is established by changing the engine from the on state to the off state only after the passage of a predetermined time interval thereafter.

### BRIEF DESCRIPTION OF THE DRAWINGS

FIG. 1 is a partially schematic, side elevation view of a moving vehicle with a system, according to the invention, for monitoring the presence of an occupant in the passenger compartment within the moving vehicle and including a sensing system capable of detecting the presence of an occupant in the passenger compartment, a detectable signal generator, and a sensor capable of detecting a state for the vehicle that could be detrimental to an occupant in the passenger compartment;

FIG. 2 is a schematic representation of one form of monitoring system, according to the present invention, and operable in response to an activating signal from an operating engine on/off sensor;

FIG. 3 is a schematic representation of a system similar to that in FIG. 2 but with a timer which causes a time delay in activation of the detectable signal generator;

FIG. 4 is a schematic representation of a monitoring system according to the present invention and operable in response to an activating signal from a temperature sensor;

FIG. 5 is a schematic representation of a monitoring system according to the present invention and operable in response to coordinated activating signals from temperature and engine on/off sensors;

FIG. 6 is a schematic representation of a further modified form of monitoring system, according to the present invention, and operable in response to an activating signal from an exit sensor;

FIG. 7 is a partially schematic representation of a portion of a vehicle, including a dashboard, and showing various, exemplary, detectable signal generators that can be used according to the present invention;

FIG. 8 is a fragmentary, side elevation view of a seat with one form of sensor for detecting the presence of an occupant on the seat; and

FIG. 9 is a view as in FIG. 8 of another form of sensor for detecting the presence of an occupant on the seat.

### DETAILED DESCRIPTION OF THE DRAWINGS

Referring initially to FIG. 1, a representative moving vehicle is shown at 10 as but one representative environment for the present invention. The moving vehicle 10 consists of a body 12 mounted upon a frame with wheels 14. The vehicle 10 has a front compartment 16 within which an engine 18 is mounted. The body 12 defines a passenger compartment 20 within which front and rear passenger seats 22, 24, respectively, are located. An exit door 26 can be opened and closed to selectively allow entry into, and exit from, the passenger compartment 20 and to secure the same.

A child safety seat 28 is shown mounted to the rear seat 24, as required by government regulations. The safety seat 28 consists of a bottom support 30, which bears the majority of the weight of the infant occupant 32, and an angled back portion 34. The bottom support 30 and back portion 34 are configured to nest into a complementary seating surface 36 on the rear vehicle seat 24. The precise configuration of the seat 28 is not key to the present invention. The safety seat 28 may be separately attached and secured to the rear seat 24, as by a belt arrangement 38, or fixedly incorporated into the rear seat 24, as is common on some recent model vehicles, typically vans.

The invention is focused principally on a system for monitoring the presence of an occupant in the passenger compartment 20 and which is capable of alerting an operator, or other person, of the existence of a state that could be detrimental to the occupant. More specifically, the system includes a number of component parts. One of the components is a sensing system 40 which is capable of detecting the presence of the occupant 32 in the passenger compartment 20. While various structures are described hereinbelow for sensing the presence of the occupant 32 in the child safety seat 28, the sensing system 40 could detect the presence of the child safety seat 28 on the rear seat 24 or the direct contact of an occupant 32 against the rear seat 24.

As an alternative to the sensing system 40, as will be described hereinbelow, which utilizes pressure or contact to detect the presence of the occupant 32 in the passenger compartment 20, a sensing system 42 can be utilized using motion sensing technology.

The sensing systems 40, 42 can be used to detect the presence of an occupant on the front seat 22, rear seat 24, or elsewhere in the passenger compartment 20, as at another seating section, or elsewhere.

Another component of the inventive monitoring system is a detectable signal generator 44, which gives to the user of the vehicle, an observer of the vehicle, or someone remote from the vehicle, a sensory indication of a state for the vehicle 10 that is potentially detrimental to the occupant in the passenger compartment 20. This potentially detrimental state is detected by one or more sensors responding to one or a combination of conditions, as an incident of which an activating signal is generated by the sensor which causes the detectable signal generator to generate a detectable signal.

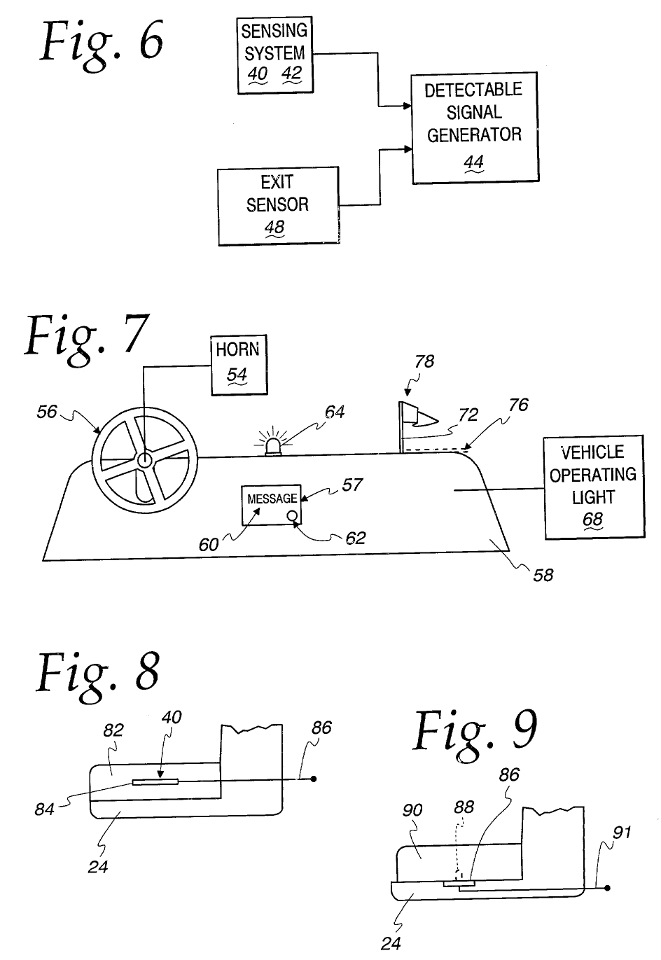

Certain of these vehicle states which are potentially threatening and dangerous to the occupant 32 will now be described. The alerting aspect of the inventive monitoring system for each such state will also be described. One dangerous state may occur when the vehicle operator exits the vehicle 10 and simply forgets that the child being transported is still in the passenger compartment 20. The user departs from the vehicle by opening the exit door 26 and then closes and possibly locks the exit door 26. The user then walks away from the vehicle, either intentionally or inadvertently leaving the child 32 in the passenger compartment 20, so that the child may be dangerously unattended. In one form of the invention, an exit sensor 48 is provided. The exit sensor 48 may be changed from a first state into a second state by either the opening of the exit door 26 or by the combined movements of opening and closing the exit door 26. As an incident of the exit sensor 48 changing from its first state into its second state, the exit sensor 48 generates an activating signal to the detectable signal generator 44, thereby giving a sensory indication that this vehicle state has occurred. This system is shown in simplified, schematic form in FIG. 6.

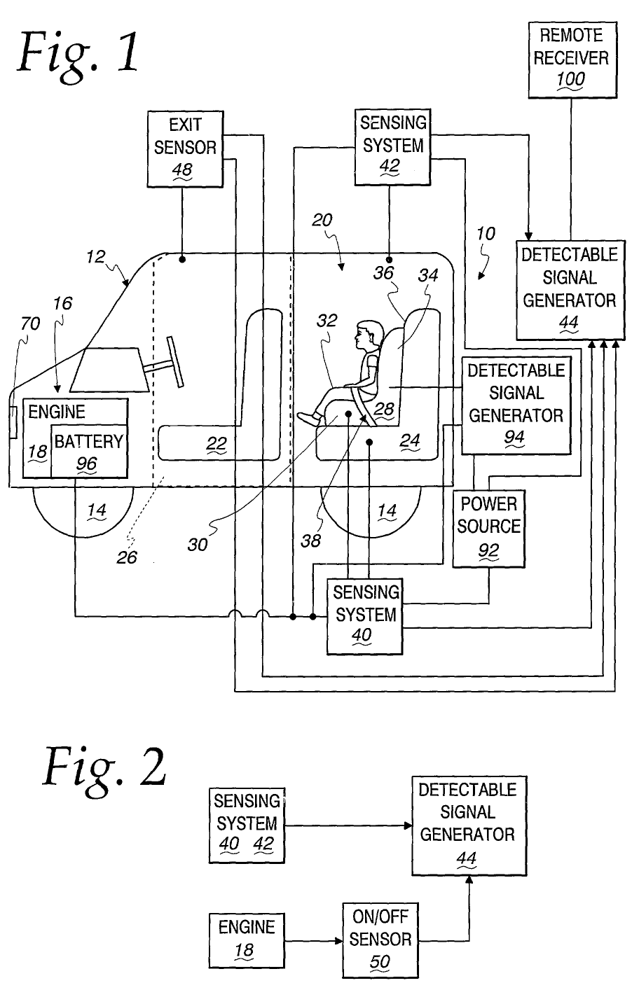

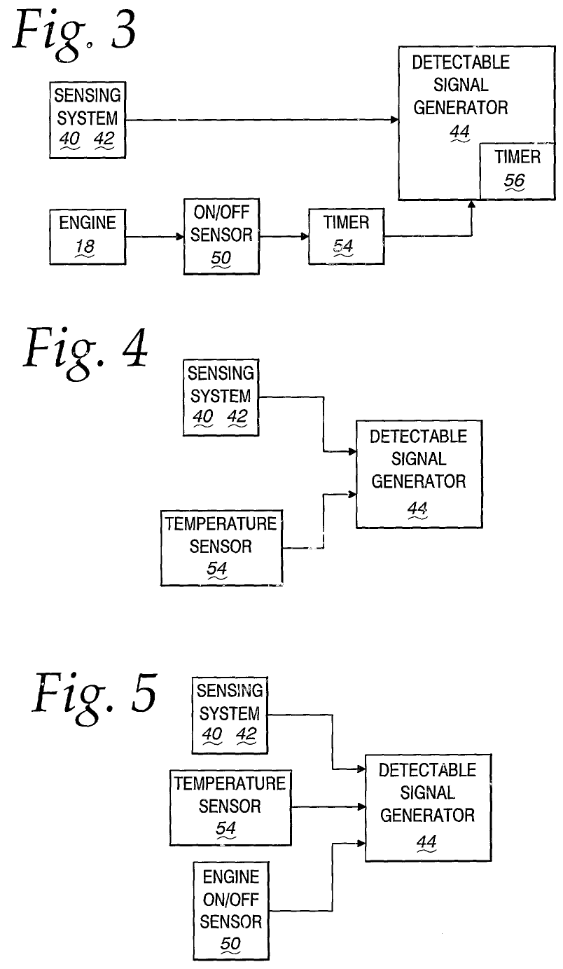

Another vehicle state that can be monitored using the inventive system results when the vehicle operator changes the operating engine 18 from its on state into its off state. As shown in FIG. 2, an on/off sensor 50 senses the changing of the engine 18 from the on state to the off state and, in response thereto, changes itself from a first state into a second state. As an incident of the sensor 50 changing from its first state into its second state, an activating signal is directed to the detectable signal generator 44. In the event that the sensing system 40, 42 detects the presence of the infant 32 in the passenger compartment 20, a detectable signal is generated by the detectable signal generator 44. Accordingly, if an operator shuts the vehicle 10 off, he/she is given a sensory reminder that the infant 32 is in the passenger compartment 20, preferably before exit from the vehicle is even attempted.

Alternatively, the system configuration shown in FIG. 2 could be modified to incorporate a timer 54 which delays the delivery of the activating signal to the detectable signal generator 44 for a predetermined time interval. This avoids the situation where the vehicle operator might otherwise be unnecessarily burdened by the signal from the detectable signal generator 44 when, in fact, the individual is aware of the presence of the infant 32 in the passenger compartment 20, and may actually be in the process of removing the infant 32 therefrom. Alternatively, a timer 56 can be incorporated into the detectable signal generator 44 to build in this delay.

Another vehicle state is one in which the temperature in the passenger compartment 20 is either excessively high or low. One form of the invention contemplates using a temperature sensor 54, as shown in FIG. 4. In the event that the temperature sensor detects temperatures above or below the predetermined temperature, an activating signal is generated to the detectable signal generator 44. Preferably, the detectable signal generator 44 will generate the signal only in the event that the sensing system 40, 42 detects the presence of the infant 32 in the passenger compartment 20.

Myriad variations of the basic system are contemplated. As just an example of additional variations is the one shown in FIG. 5. In FIG. 5, a temperature sensor 54 and engine on/off sensor 50 are used simultaneously and their activating signals coordinated so as to cause the detectable signal generator 44 to produce the detectable signal only with the engine either on or off and temperature level above or below predetermined levels.

The invention contemplates a virtually limitless number of different signals that may be generated by the detectable signal generator 44. FIG. 7 shows a number of representative signals that may be generated by the detectable signal generator 44. In one form, a horn 54; conventionally operated through a button on the steering wheel 56, can function as the detectable signal generator 44 to produce a continuous or intermittent noise.

Alternatively, the display 56 may be located on the vehicle dashboard 58, or elsewhere, to provide either a visual message at 60, or a voice message as through a speaker 62, alerting the vehicle operator of the potentially dangerous vehicle state, be it the unattended state of the infant 32 and/or the presence of the infant 32 in the passenger compartment 20 in an excessively hot or cold environment.

As a further alternative, a dedicated light 64 may be illuminated by the detectable signal generator 44. The light 64 may be a strobe light, a flashing light, etc.

As a further alternative, the detectable signal generator 44 may cause illumination, either continuously or intermittently, of one of the conventional operating lights 68 on the vehicle 10. The operating lights 68 may be a headlight 70, as shown in FIG. 1, or brake lights, turn signals, running lights, etc.

As a still further alternative, some type of mechanical device, such as a flag, at 72 in FIG. 7, may be repositioned from a first state, shown in dotted lines at 76, to a second state, as shown in solid lines at 78. The flag 72 may be within the vehicle compartment or at the exterior of the vehicle 10. Myriad different mechanical devices capable of changing state could be used.

One version of the sensing system 40, that is pressure responsive, is shown in FIG. 8. In FIG. 8, a cushion 82 has a pressure sensor 84 incorporated therein. The cushion 82 may be part of the child safety seat 28 or placed directly upon the rear seat 24 or front seat 22 of the vehicle 10. The sensor 84 can be electrically connected through a lead 86, or otherwise, to generate a signal indicative of the presence of the infant 32 in the child safety seat 28 or on the rear seat 24.

As an alternative design, a pressure sensitive switch 86 is provided with a depressible actuating button 88. The sensor 86 may be incorporated into the rear seat 24 or the child safety seat 28. In either event, by placement of a cushion 90 over the button 88 and application of pressure resulting from the weight of the infant 32, the sensor 86 is placed in a state which is indicative of the presence of the infant 32 in the passenger compartment 20. The sensor 86 has an electrical lead 90 which allows its integration into the systems as previously described herein. Of course, wireless communication between components is contemplated for all embodiments herein. Any number and type of sensors can be used to determine the presence of an infant in the passenger compartment. The above embodiments are merely exemplary in nature.

The inventive monitoring system can be integrally formed into the vehicle 10 at time of manufacture, or permanently retrofitted. Alternatively, the system can be portable, self-contained, and removable. As just one example, as shown in FIG. 1, the child safety seat 28 can be provided with its own power source 92 together with a detectable signal generator 94 that may be transportable with the child safety seat 28. The system may be alternatively powered by, for example, the battery 96 used for the vehicle engine 18. A permanent or temporary connection can be made between the system and the battery 96.

With the inventive system, sensory signals can be generated indicative of the fact that a potentially dangerous condition exists for an infant in the passenger compartment. The sensory signal can be a signal within the vehicle compartment or something that can be clearly seen from externally of the vehicle and/or from a remote location. For example, the detectable signal generator 44 could communicate with a remote receiver 100 to alert the vehicle operator or another individual of the dangerous state. By incorporating the inventive system, needless injuries to, and potentially death of, helpless victims may be avoided.

The foregoing disclosure of specific embodiments is intended to be illustrative of the broad concepts comprehended by the invention.

1. A method of monitoring the presence of an occupant in a passenger compartment of a moving vehicle having an operating engine with on and off states, the method comprising the steps of:
providing a sensing system on the moving vehicle which detects the presence of an occupant in the passenger compartment of the moving vehicle;
providing a detectable signal generator; and
causing the detectable signal generator to generate a detectable signal in the event that at least one of a) the temperature in the passenger compartment changes to above or below a predetermined temperature with the sensing system detecting the presence of an occupant in the passenger compartment of the moving vehicle; b) the operating engine is in the off state with the sensing system detecting the presence of an occupant in the passenger compartment of the moving vehicle; c) a user exits from the vehicle with the sensing system detecting the presence of an occupant in the passenger compartment of the moving vehicle; and d) the operating engine is changed from the on state to the off state with the sensing system detecting the presence of an occupant in the passenger compartment of the moving vehicle.

2. The method of monitoring the presence of an occupant in a passenger compartment of a moving vehicle according to claim 1 wherein the step of causing the detectable signal generator to generate a detectable signal comprises placing a temperature sensor in the passenger compartment of the moving vehicle and causing the temperature sensor to generate an activating signal upon the temperature in the passenger compartment changing to above or below the predetermined temperature to thereby cause the signal generator to generate the detectable signal.

3. The method of monitoring the presence of an occupant in a passenger compartment of a moving vehicle according to claim 2 wherein the detectable signal generator comprises at least one of a) a sound generator; b) an illumination source; c) a visual display; d) a mechanical assembly that is capable of changing state; and e) a horn.

4. The method of monitoring the presence of an occupant in a passenger compartment of a moving vehicle according to claim 2 wherein the sensing system comprises a pressure responsive sensor which is changeable from a first state into a second state upon detecting the presence of a passenger in the passenger compartment of the moving vehicle.

5. The method of monitoring the presence of an occupant in a passenger compartment of a moving vehicle according to claim 2 wherein the sensing system comprises a sensor for motion within the passenger compartment of the moving vehicle.

6. The method of monitoring the presence of an occupant in a passenger compartment of a moving vehicle according to claim 4 wherein the sensing system is operably associated with a child safety seat in the passenger compartment of the moving vehicle.

7. The method of monitoring the presence of an occupant in a passenger compartment of a moving vehicle according to claim 2 wherein the moving vehicle has an exit door that can be selectively opened and closed and further including the step of providing an exit sensor which is changeable from a first state into a second state upon detecting that the exit door has one of a) opened and b) opened and closed, the exit sensor generating an activating signal as an incident of the exit sensor changing from the first state into the second state to thereby cause the detectable signal generator to generate a detectable signal.

8. The method of monitoring the presence of an occupant in a passenger compartment of a moving vehicle according to claim 2 further including the step of providing an engine state sensor which is changeable from a first state into a second state as an incident of the engine being changed from the on state into the off state, the engine state sensor generating an activating signal as an incident of the engine state sensor changing from the first state into the second state to thereby cause the detectable signal generator to generate a detectable signal.

9. The method of monitoring the presence of an occupant in a passenger compartment of a moving vehicle according to claim 8 wherein the activating signal is generated only after a predetermined time lapse after the engine state sensor is changed from the first state into the second state.

10. In combination:
a) a moving vehicle having a passenger compartment, an operating engine having on and off states, and an exit door that can be selectively opened and closed; and
b) a system for monitoring the presence of an occupant in the passenger compartment of the moving vehicle, the monitoring system comprising:
a sensing system capable of detecting the presence of an occupant in the passenger compartment of the moving vehicle; and
a detectable signal generator capable of generating a detectable signal in the event that: i) at least one of a) the temperature in the passenger compartment changes to above or below a predetermined temperature, b) the operating engine is in the off state, c) a user exits from the vehicle, and d) the operating engine is changed from the on state to the off state; and ii) the sensing system detects the presence of an occupant in the passenger compartment of the moving vehicle.

11. The combination according to claim 10 wherein the detectable signal generator comprises a temperature sensor in the passenger compartment of the moving vehicle that generates an activating signal upon detecting that the temperature in the passenger compartment of the moving vehicle has changed to above or below the predetermined temperature to thereby cause the detectable signal generator to generate a detectable signal.

12. The combination according to claim 10 wherein the detectable signal generator comprises at least one of a) a sound generator; b) an illumination source; c) a visual display; d) a mechanical assembly that is capable of changing state; and e) a horn.

13. The combination according to claim 10 wherein the sensing system comprises a pressure responsive sensor which is changeable from a first state into a second state upon detecting the presence of a passenger in the passenger compartment of the moving vehicle.

14. The combination according to claim 10 wherein the sensing system comprises a sensor for mounting within the passenger compartment of the moving vehicle.

15. The combination according to claim 13 further comprising a child safety seat, wherein the sensing system is operably associated with the child safety seat in the passenger compartment of the moving vehicle.

16. The combination according to claim 10 wherein the system for monitoring the presence of an occupant in the moving vehicle further comprises an exit sensor which is changeable from a first state into a second state upon detecting that the exit door has one of a) opened and b) opened and closed, the exit sensor generating an activating signal as an incident of the exit sensor changing from the first state into the second state to thereby cause the detectable signal generator to generate a detectable signal.

17. The combination according to claim 10 wherein the system for monitoring the presence of an occupant in the moving vehicle further comprises an engine state sensor which is changeable from a first state into a second state as an incident of the engine being changed from the on state into the off state, the engine state sensor generating an activating signal as an incident of the engine state sensor changing from the first state into the second state to thereby cause the detectable signal generator to generate a detectable signal.

18. The combination according to claim 17 wherein the activating signal is generated only after a predetermined time lapse after the engine state sensor is changed from the first state into the second state.

19. A system for monitoring the presence of an occupant in the passenger compartment of a moving vehicle, having an operating engine with on and off states and an exit door that can be selectively opened and closed, the monitoring system comprising:
a sensing system capable of detecting the presence of an occupant in a passenger compartment of a moving vehicle;
a detectable signal generator; and
a sensor capable of detecting a state for a moving vehicle that could be detrimental to an occupant in a passenger compartment of a moving vehicle,
the sensor generating an activating signal upon detecting the moving vehicle state and thereby causing the detectable signal generator to generate a detectable signal with the sensing system detecting the presence of an occupant in a passenger compartment of a moving vehicle.

20. The system for monitoring the presence of an occupant in the passenger compartment of a moving vehicle according to claim 19 wherein the moving vehicle state is established upon the temperature in the passenger compartment of a moving vehicle changing to above or below a predetermined temperature.

21. The system for monitoring the presence of an occupant in the passenger compartment of a moving vehicle according to claim 19 wherein the moving vehicle state is established by opening and closing an exit door on a moving vehicle.

22. The system for monitoring the presence of an occupant in the passenger compartment of a moving vehicle according to claim 19 wherein the moving vehicle state is established by changing an engine on a moving vehicle from the on state to the off state.

23. The system for monitoring the presence of an occupant in the passenger compartment of a moving vehicle according to claim 19 wherein the moving vehicle state is established by changing an engine from the on state to the off state and upon the passage of a predetermined time interval.
